(19) United States
(12) Patent Application Publication
(10) Pub. No.: US 2014/0164056 A1
(43) Pub. Date: Jun. 12, 2014

(54) Biosensitive response evaluation for design and research

(71) Applicant: Cascade Strategies, Inc., Issaquah, WA (US)

(72) Inventors: Gerald Buchanan Johnson, Bellevue, WA (US); Ari Hollander, Seattle, WA (US)

(73) Assignee: Cascade Strategies, Inc., Issaquah, WA (US)

(21) Appl. No.: 13/998,798

(22) Filed: Dec. 10, 2013

Related U.S. Application Data
(63) Continuation-in-part of application No. 13/694,757, filed on Jan. 2, 2013.
Application No. 13/694,757 is a continuation-in-part of application No. PCT/US2013/044600, filed on Jun. 6, 2013.
(60) Provisional application No. 61/734,899, filed on Dec. 7, 2012.
(60) Provisional application No. 61/734,899, filed on Dec. 7, 2012.

(30) Foreign Application Priority Data
Jun. 6, 2013 (US) PCT/US2013/044600

(51) Int. Cl. G06Q 30/02

(52) U.S. Cl. CPC G06Q 30/0201
USPC 705/7.29

(57) ABSTRACT

Biosensitive response evaluation improves both design and marketing research by combining eye tracking information with time-coded biosensor information to determine the relative brain state of various market research respondents at the precise moment they are exposed to a stimulus. Areas of interest (AOI) are demarcated on detected objects. Relative physiological effects associated with each demarcated AOI are identified as part of biosensor response data and may be directly statistically correlated with a subsequent action.

### CROSS-REFERENCE TO RELATED APPLICATIONS

This application claims the benefit of priority to U.S. Provisional Patent Application No. 61/734,899; titled “PACKAGE DESIGN AND MARKET RESEARCH SYSTEM AND METHOD”; filed Dec. 7, 2012 under Attorney Docket No. NIMB-2012003; and naming inventors Gerald B. JOHNSON and Ari HOLLANDER and is a continuation-in-part of U.S. patent application Ser. No. 13/694,757; titled “BIOSENSITIVE RESPONSE EVALUATION FOR DESIGN AND RESEARCH”; filed Dec. 31, 2012, naming inventors Gerald B. JOHNSON and Ari HOLLANDER and is a continuation-in-part of international patent application PCT/US2013/044600, titled “BIOSENSITIVE RESPONSE EVALUATION FOR DESIGN AND RESEARCH”; filed Jun. 6, 2013, naming inventors Gerald B. JOHNSON and Ari HOLLANDER. The above-cited applications are incorporated herein by reference in their entirety, for all purposes.

### FIELD

This disclosure relates generally to product design and marketing research. More specifically, but not by way of limitation, to systems and methods for the design, copy testing, and biosensitive response evaluation of product packaging and associated planograms.

### BACKGROUND

Modern advertisers, package designers, and product marketers dedicate considerable resources and time to the systematic gathering and interpretation of marketing information in an effort to gain insight or support decision making regarding products, individuals, or organizations. Using various statistical and analytical methods in combination with techniques of the applied social sciences, the marketing industry tries to determine what will produce sales. Unfortunately, available design and research processes require designers and market researchers to duplicate their design efforts, which not only make development of new product packaging both expensive and time consuming but ironically also only produce indefinite results. Moreover, as the gathered research results are often based on self-reported data that is collected well after the initial exposure, the results cannot provide the detail desired by designers and market researchers. Existing methodologies only analyze a new product package design in toto, so there is no way of determining whether certain parts of a package design produce desirable physiological effects in consumers. Additionally, as individual evaluation of package parts is not possible using existing methods, attempting to accurately correlate the predicted effects of changes to a particular package part with sales for the product is also not possible.

### BRIEF DESCRIPTION OF THE DRAWINGS

The present disclosure will be presented by way of exemplary embodiments but not limitations, illustrated in the accompanying drawings in which like references denote similar elements, and in which:

FIG. 1 illustrates a block diagram view of a suitable operating environment for biosensitive design systems in accordance with various embodiments.

FIG. 2 illustrates a block diagram view of a suitable operating environment for biosensitive design research systems in accordance with various embodiments.

FIG. 3 illustrates several components of a product package design device having a touch display in accordance with various embodiments.

FIG. 4 illustrates several components of a research device with a biosensor in accordance with various embodiments.

FIG. 5 illustrates several components of a market research server in accordance with various embodiments.

FIG. 6 illustrates a block diagram view of several components of a biosensitive response evaluation device having at least one eye tracking device, such as an optical biosensor, and at least one other biosensor in accordance with various embodiments.

FIG. 7A illustrates a block diagram view of several components of product package design data in accordance with various embodiments.

FIG. 7B illustrates a graphical view of surface information associated with the product package design data previously shown in FIG. 7A

FIG. 7C illustrates a graphical view of areas of interest (AOI) associated with the product package design data previously shown in FIGS. 7A & 7B in accordance with various embodiments.

FIG. 8 is a graphical view of a suitable marketing stimulus in accordance with various embodiments.

FIG. 9 is a graphical view of suitable areas of interest (AOI) associated with the marketing stimulus shown in FIG. 8 in accordance with various embodiments.

FIG. 10 is a communication diagram of a product package design system in accordance with various embodiments.

FIG. 11 is a table view of collected consumer response data of measurable physiological states in accordance with various embodiments.

FIG. 12 illustrates a 3D graphical view with highlighted areas of interest (AOI) associated with the back, side, and bottom of a product package design in accordance with various embodiments.

FIG. 13 illustrates a 3D graphical view with highlighted AOI associated with the front, side, and bottom of a product package design in accordance with various embodiments.

FIG. 14 illustrates a 3D graphical view with highlighted AOI associated with the back and bottom of a product package design in accordance with various embodiments.

FIG. 15 illustrates a block diagram view of several components of a biosensitive response evaluation system when the mode of detection is a physical object occurring in space in accordance with various embodiments.

FIG. 16 illustrates a block diagram view of several components of a biosensitive response evaluation system without requiring that the stimuli be sub-objects or bitmap regions on objects in virtual reality simulations in accordance with various embodiments.

### DESCRIPTION

In accordance with various embodiments of the invention, biosensitive response evaluation systems and methods are described that overcome the hereinafore-mentioned disadvantages of the heretofore-known devices of this general type and that provide for dynamic design, copy testing, and biosensitive response evaluation of product packaging and associated planograms. More specifically, the described embodiments provide package designers and product marketers with the ability to identify which parts of the package design are working hardest to produce sales. This enables the designers who develop packages for retail products to emphasize those elements in future package designs that are most productive in contributing to the sale of the product In fact, the described biosensitive response evaluation system can be applied to any marketing stimulus that can be divided into parts, each part having some motivating power to spur consumers to take an action, like buy the product. For example, a consumer concerned with sugar content might be moved to buy a particular cereal upon seeing an appropriate marketing stimulus, such as part of an ad or a web page that indicates the cereal has “low sugar”.

Examples of such a biosensitive response evaluation systems include BioNimbus™, NeuroNimbus™, and NimbusTouch™, which may both be obtained from Nimbus Online, Inc. a subsidiary of Cascade Strategies, Inc. (see e.g., www.cascadestrategies.com) allows a marketer to evaluate whether all the elements or parts of designated marketing materials are working on the consumer as effectively as possible to produce a desired outcome, in accordance with at least one embodiment as described,.

The detailed description that follows is represented largely in terms of processes and symbolic representations of operations by conventional computer components, including a processor, memory storage devices for the processor, connected display devices and input devices. Although conventional computer components have been described that generally conform to conventional general purpose computing devices, a biosensitive response evaluation system may include any of a great number of devices capable of communicating with a communication network, such as the Internet. For purposes of this disclosure, the terms “network”, “computer network”, and “communication network” are synonymous and generally refer to a collection of hardware components and computers interconnected by communication channels that allow sharing of resources and information. Both a local area network (LAN) and a wide area network (WANs) are examples of computer networks that acceptably interconnect computers within the scope of this disclosure.

Furthermore, these processes and operations may utilize conventional computer components in a heterogeneous distributed computing environment; including remote file servers, computer servers, publishing resources, and/or memory storage devices. Each of these conventional distributed computing components is accessible by the processor via a communication network. In a heterogeneous distributed computing environment, clients, servers, and client/servers may be, for example, mainframes, minicomputers, workstations, or personal computers. Most services in a heterogeneous distributed computing environment can be grouped into one of these major categories: distributed file system, distributed computing resources, and messaging. A distributed file system provides a client with transparent access to part of the mass storage of a remote network device, such as a server. Distributed computing resources provide a client with access to computational or processing power of remote network devices, such as a cloud server. In one embodiment, distributed computing resources also provide a device with access to remote resources, such as computational assets associated with remote network devices. More specifically, these distributed product resources may even be available from multiple different service providers.

Various aspects of the illustrative embodiments will be described using terms commonly employed by those skilled in the art to convey the substance of their work to others skilled in the art. For instance, for purposes of this disclosure, the term “biosensor” refers to an analytical device, used for the detection of different types of biometric data. Examples include, but are not limited to, eye tracking systems, facial expression recognition systems, electro encephalography systems (EEG), galvanic skin response sensors, heart rate monitors, heart rate variability sensors, blood volume pulsimetry sensors, Electrocardiography (EKG) systems, Electromyography (EMG) systems, respiration sensors, spatial tracking sensors for gesture identification or physical manipulation analysis, and other similar sensors and systems for collecting biometric data. Similarly, for purposes of this disclosure, the terms “areas of interest” and/or “AOI” both refer to one or more 2D or 3D objects or parts of 2D or 3D objects that may be of interest to a deployer of the application. AOIs can be specified in screen coordinates or in terms of locations on the surfaces of 2D or 3D objects. In some embodiments, these surface locations are specified by surface coordinates of a 2D object or a 3D object or by one or more bitmaps registered to surface coordinates. In this way an arbitrary number of categories or pieces of data may be associated with any object, group of objects, or portion of an object in a scene in the application. These categories or pieces of data can be correlated in real-time with any biometric state, decision, or preference detected by a biosensor and/or expressed by a end-user of the system.

The phrases “in one embodiment,” “in various embodiments,” “in some embodiments,” and the like are used repeatedly. Such phrases do not necessarily refer to the same embodiment, but they may unless the context dictates otherwise. The terms “comprising,” “having,” and “including” are synonymous, unless the context dictates otherwise.

Embodiments described herein, as will be apparent to those skilled in the art, may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments. Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

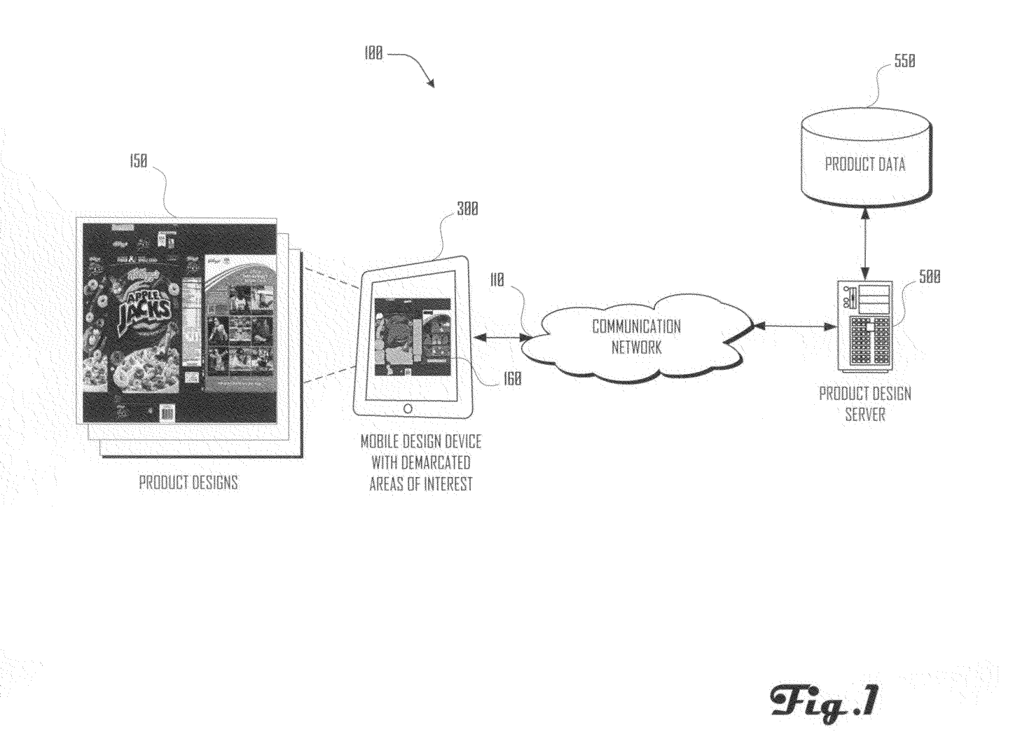

Referring now to FIG. 1, a suitable operating environment for a biosensitive design system 100 is shown in accordance with various embodiments. The biosensitive design system 100 includes a mobile design device 300 in communication with a product design server 500 via communication network 110. The product design server 500 maintains product data 550 for a variety of product designs 150 and associated planograms. In one embodiment, product designers and market researchers can obtain base product designs from the stored product data 550 and modify the stored template into a new product design on the touch-based interface of the mobile design device 300. In one embodiment, changes to the new product design are dynamically stored locally and optionally in the product data 550. In one embodiment, the system 100 tracks the finger swipes of designers using touch screens to identify and demarcate areas of interest (AOI) 160 in the product designs 150. The AOI 160 may also be demarcated by identifying various surface parts of the product designs 150. Examples of suitable AOI may include package elements, such as logos, images, text blocks, and informational areas like ingredients, promotional snipes, and so forth. As previously stated, the term AOI refers to one or more 2D or 3D objects or parts of 2D or 3D objects that may be of interest to a deployer/user of the application. In this way an arbitrary number of categories or pieces of data may be associated with any object, group of objects, or portion of an object in a scene in the application. These categories or pieces of data can be correlated in real-time with any biometric state, decision, or preference detected and/or expressed by a end-user of the system. For example, in one embodiment, the system may correlate data by use of a ray-casting algorithm projecting a virtual ray along the gaze direction as measured by an eye tracing device. The virtual ray may intersect one or more AOIs and establish the aforementioned correlation. In some embodiments the angle of intersection and or order of intersection and or distance of intersection may be used to determine the angular size and degree of visibility of the AOI. In some embodiments ray-casting may be used to detect views of AOIs even when seen through other transparent or partially transparent objects which may themselves include intersected AOIs

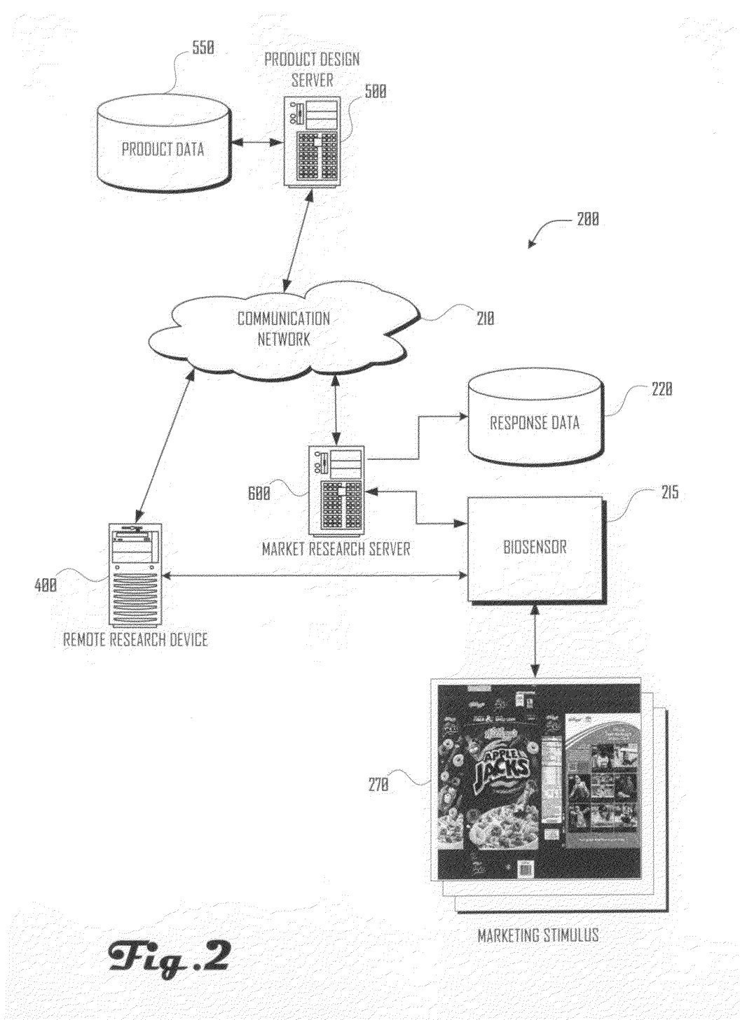

The mobile design device 300 also allows designers to graphically move products in and out of shelf sets or planograms, which provide a visual digital representation of a store's products. Planograms are a useful tool for visual merchandising and as such may also be stored with the product data 550. The system 100 tracks the finger swipes of designers using touch screens of the mobile design device 300 to modify parts of the product designs 150 and/or to change a variety of planograms for filling shelves and previewing new product designs in realistic retail contexts. In one embodiment, desired changes and modifications by the designer to the product designs 150, AOI 160, and product planograms may be stored to the product data 550. In this manner, updates to product designs 150, AOI 160, and product planograms are accessible from the product data 550 by market researchers. Similarly, as shown below in FIG. 2, market research may reveal optimal visual product placement of particular product designs and update the associate planograms stored in product data 550.

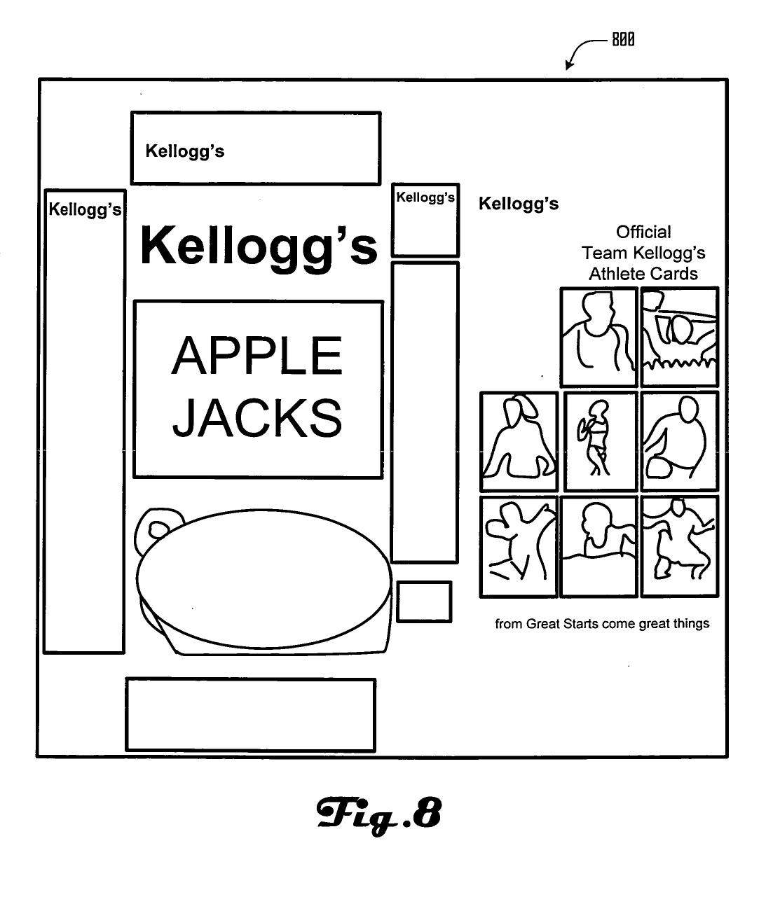

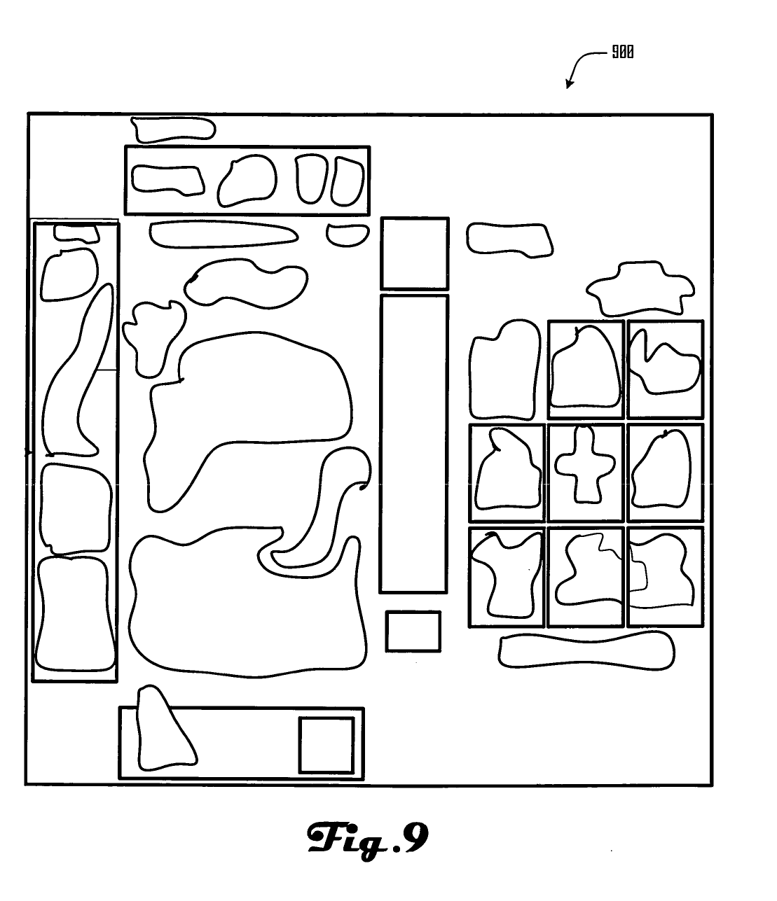

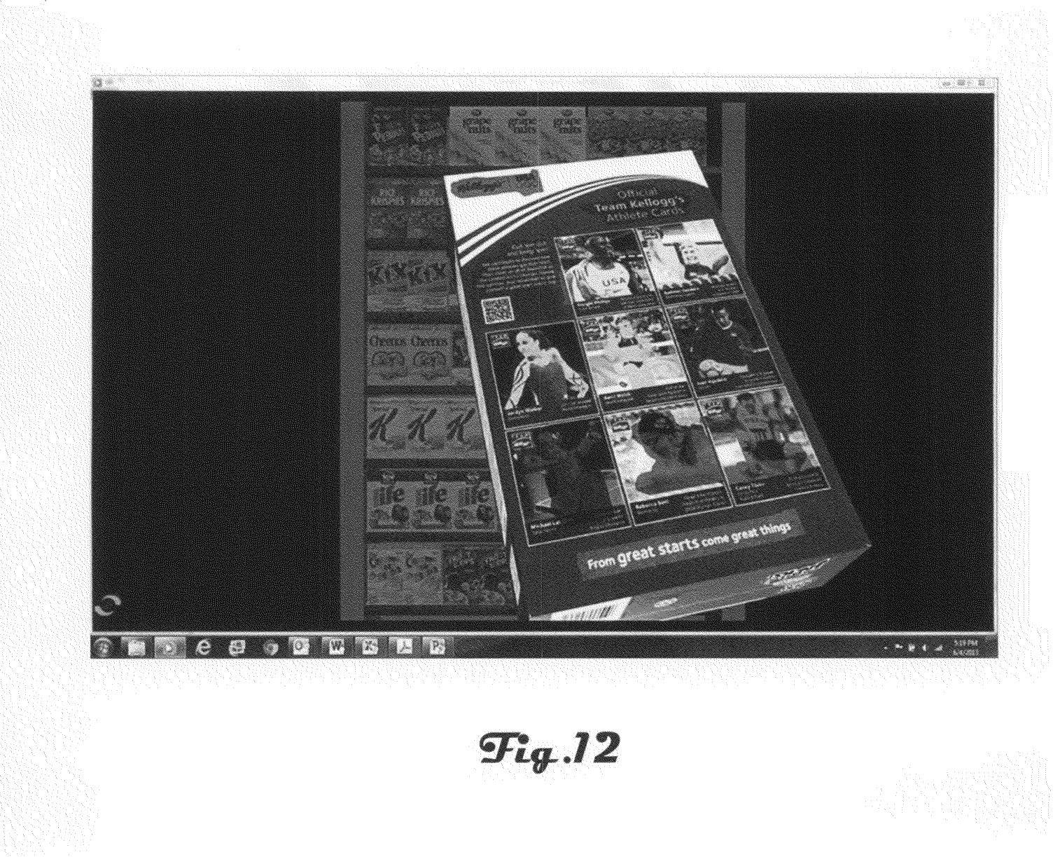

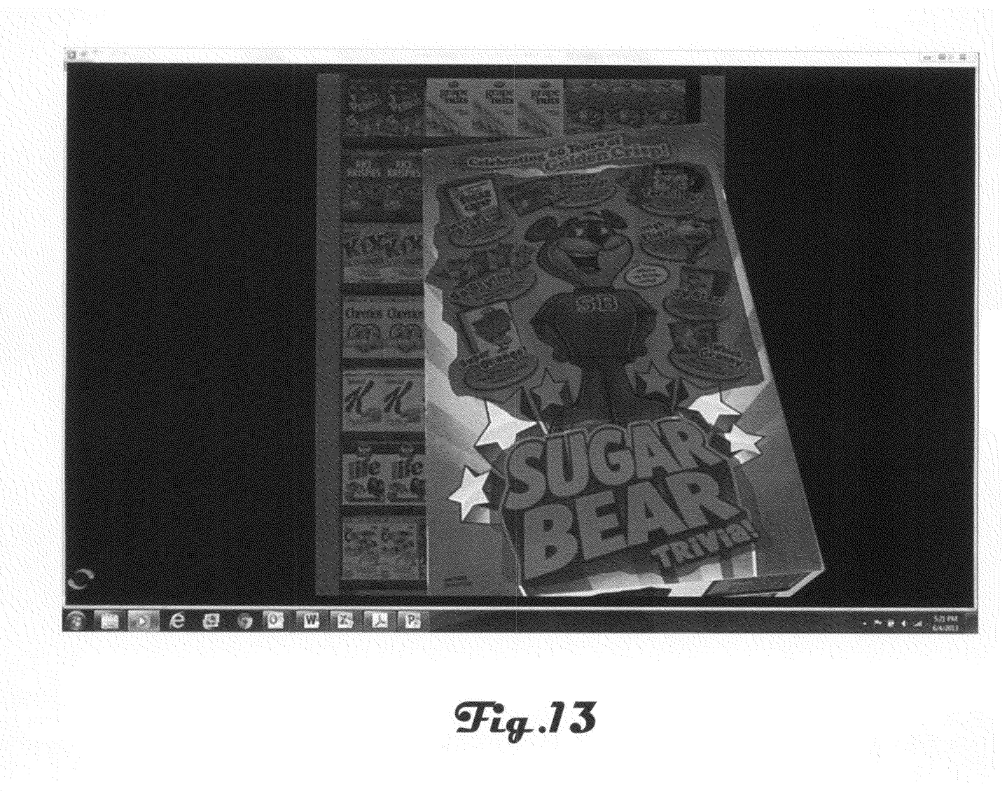

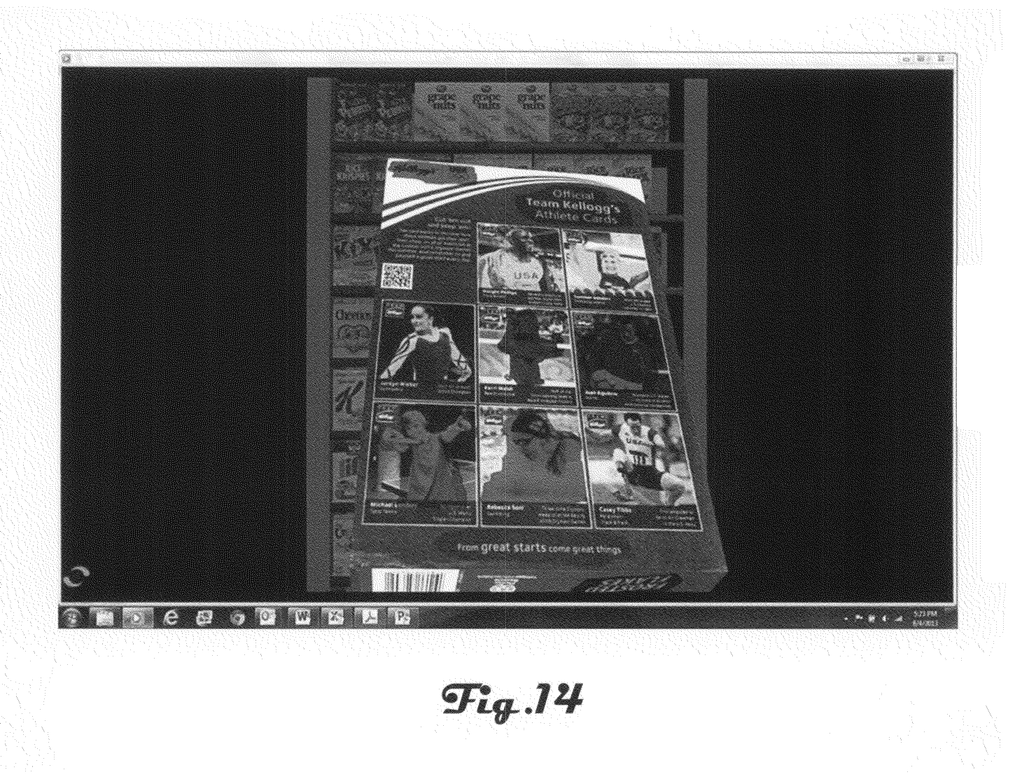

Referring now to FIG. 2, a suitable operating environment for a biosensitive design research system 200 is shown in accordance with various embodiments. The biosensitive design research system 200 includes a market research server 600 in communication with a remote research device 400 across communication network 210. The research device 400 having at least one biosensor 215 for collecting biometric response data 220 to marketing stimulus 270. In one embodiment, the marketing stimulus 270 may be retrieved from the product data 550 via the product design server 500. Additionally, in one embodiment, the response data 220 may be correlated with the marketing stimulus 270 and saved with the associated product data 550 for use in future designs. FIG. 8 provides a graphical view of a suitable marketing stimulus 800 in accordance with various embodiments. Similarly, FIG. 9 is a graphical view of suitable areas of interest (AOI) 900 associated with the marketing stimulus 800 shown in FIG. 8 in accordance with various embodiments. FIGS. 12-14 show examples of different 3D graphical views of suitable marketing stimulus each with highlighted AOI on at least two of the front, back, left side, right side, top, and bottom portions of a product package design. As the 3D object is rotated different AOI become visible and may be tracked by the research device. Examples of suitable AOI may include package elements, such as logos, images, text blocks, and informational areas like ingredients, promotional snipes, and so forth. The AOI may refer to one or more 2D or 3D objects or parts of 2D or 3D objects that may be of interest. In this way an arbitrary number of categories or pieces of data may be associated with any object, group of objects, or portion of an object in a scene in the application. These categories or pieces of data can be correlated in real-time with any biometric state, decision, or preference detected and/or expressed by a end-user of the system. For example, in one embodiment, the system may correlate data by use of a ray-casting algorithm projecting a virtual ray along the gaze direction as measured by an eye tracing device. The virtual ray may intersect one or more AOIs and establish the aforementioned correlation. In some embodiments the angle of intersection and or order of intersection and or distance of intersection may be used to determine the angular size and degree of visibility of the AOI. In some embodiments ray-casting may be used to detect views of AOIs even when seen through other transparent or partially transparent objects which may themselves include intersected AOIs.

The biosensitive design research system 200 provides designers from the moment of earliest conceptualization about a package design a way to incorporate that design into the kind of clutter environment that consumer test respondents will really see and use. Designers may modify a variety of elements in that environment, such as the placement of the number and type of packages on the shelves, the choice of competitors to be placed adjacent to the new (or current) packages, prices, shelf arrangement (e.g., height, number of shelves, etc.), signage, promotional elements, and so forth. These configurations may be saved by the designers as planograms associated with the product design. In one embodiment, the biosensitive design research system 200 simultaneously and immediately records both the graphic changes made by designers and the metric changes to back end data files in the product data 550 that will eventually be needed for simulations during the market research phase. This allows the design that will be tested with consumers to move seamlessly from the graphic arena of design to the metric arena of research.

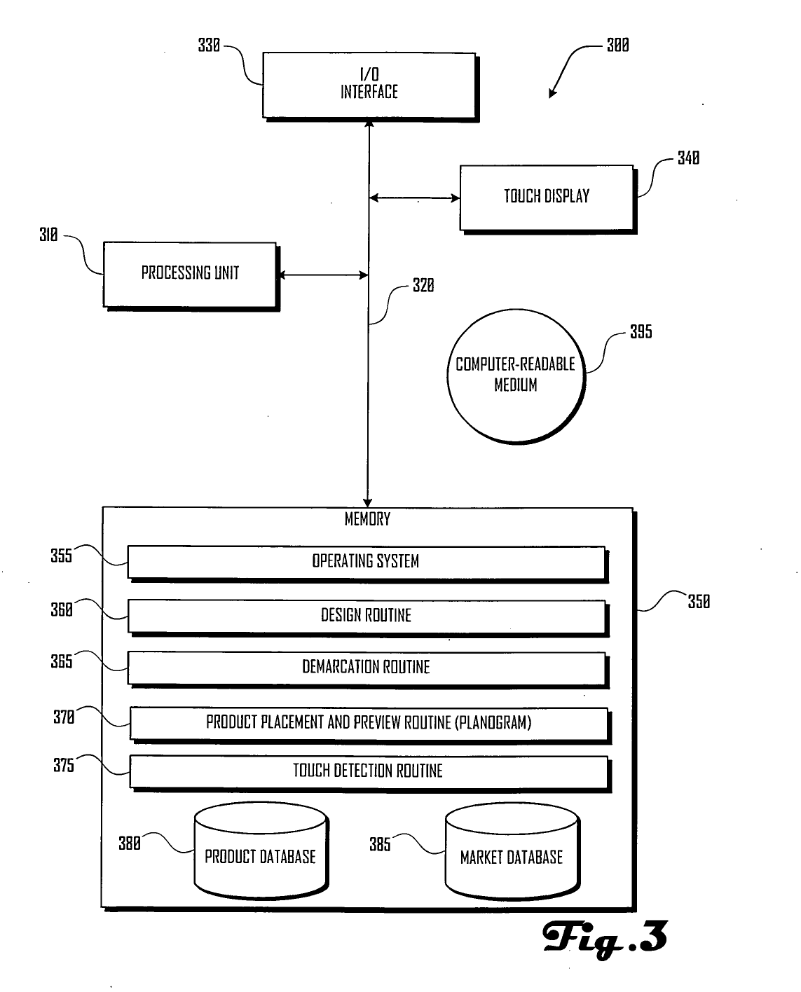

Referring now to FIG. 3, several components of a product package design device 300 is shown in accordance with various embodiments. In some embodiments, the product package design device 300 may include many more components than those shown in FIG. 3. However, it is not necessary that all of these generally conventional components be shown in order to disclose an illustrative embodiment. As shown in FIG. 3, the product package design device 300 includes an I/O communication interface 330 for connecting to the communication network 110. The product package design device 300 also includes a processing unit 310, a memory 350, and a touch-sensitive display interface 340, all interconnected along with the I/O interface 330 via a communication bus 320. The memory 350 generally comprises a random access memory (“RAM”), a read only memory (“ROM”), and a permanent mass storage device, such as a disk drive, flash device, or the like. The memory 350 stores program code for a number of applications, which includes executable instructions for design routine 360, demarcation routine 365, product placement and preview routine 370, and touch detection routine 375.

In addition, the memory 350 also stores an operating system 355, a product database 380, and a market database 385. These software components may be loaded from a computer readable storage medium 395 into memory 350 of the package design device 300 using a read mechanism (not shown) associated with a non-transient computer readable storage medium 395, such as a floppy disc, tape, DVD/CD-ROM drive, memory card, USB drive, or the like. In some embodiments, software components may also be loaded via the I/O communication interface 330, rather than via a computer readable storage medium 395. As previously indicated, the product database 380 and market database 385 may include data for base product information and planogram configuration information associated with different active product package designs and a visual representation or model that indicates the placement of retail products on shelves in order to maximize sales.

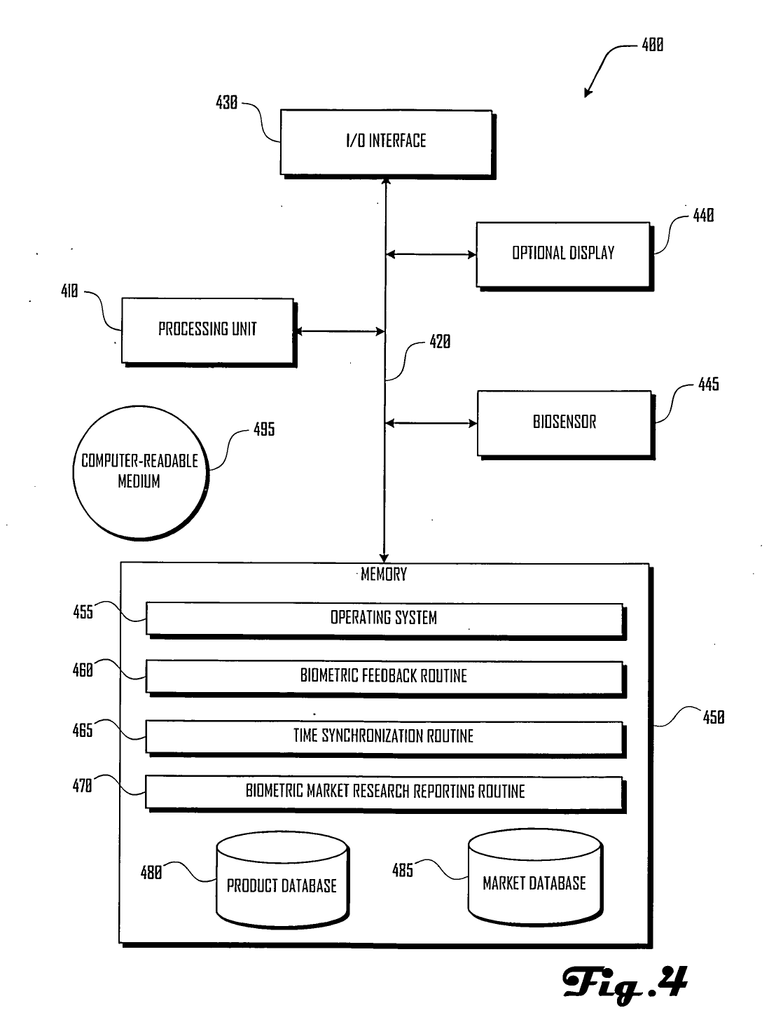

Referring now to FIG. 4, several components of a marketing stimulus research device 400 with a biosensor 445 are shown in accordance with various embodiments. In some embodiments, the research device 400 may include many more components than those shown in FIG. 4. However, it is not necessary that all of these generally conventional components be shown in order to disclose an illustrative embodiment. As shown in FIG. 4, the research device 400 includes an I/O communication interface 430 for connecting to the communication network 210. In addition to the biosensor 445, the research device 400 also includes a processing unit 410, a memory 450, and an optional display interface 440, all interconnected along with the I/O interface 430 via a communication bus 420. The memory 450 generally comprises a random access memory (“RAM”), a read only memory (“ROM”), and a permanent mass storage device, such as a disk drive, flash device, or the like. The memory 450 stores program code for a number of applications, which includes executable instructions for biometric feedback routine 460, time synchronization routine 465, and biometric market research reporting routine 470.

In addition, the memory 450 also stores an operating system 455, a product database 480, and a market database 485. These software components may be loaded from a computer readable storage medium 495 into memory 450 of the research device 400 using a read mechanism (not shown) associated with a non-transient computer readable storage medium 395, such as a floppy disc, tape, DVD/CD-ROM drive, memory card, USB drive, or the like. In some embodiments, software components may also be loaded via the I/O communication interface 430, rather than via a computer readable storage medium 495. As previously indicated, the product database 480 and market database 485 may include product information and planogram information associated with different product package designs. This information may be useful in creating a visual representation or model of a retail environment that places a variety of products on shelves and may provide marketing stimulus for consumer being monitored by the biosensor 445.

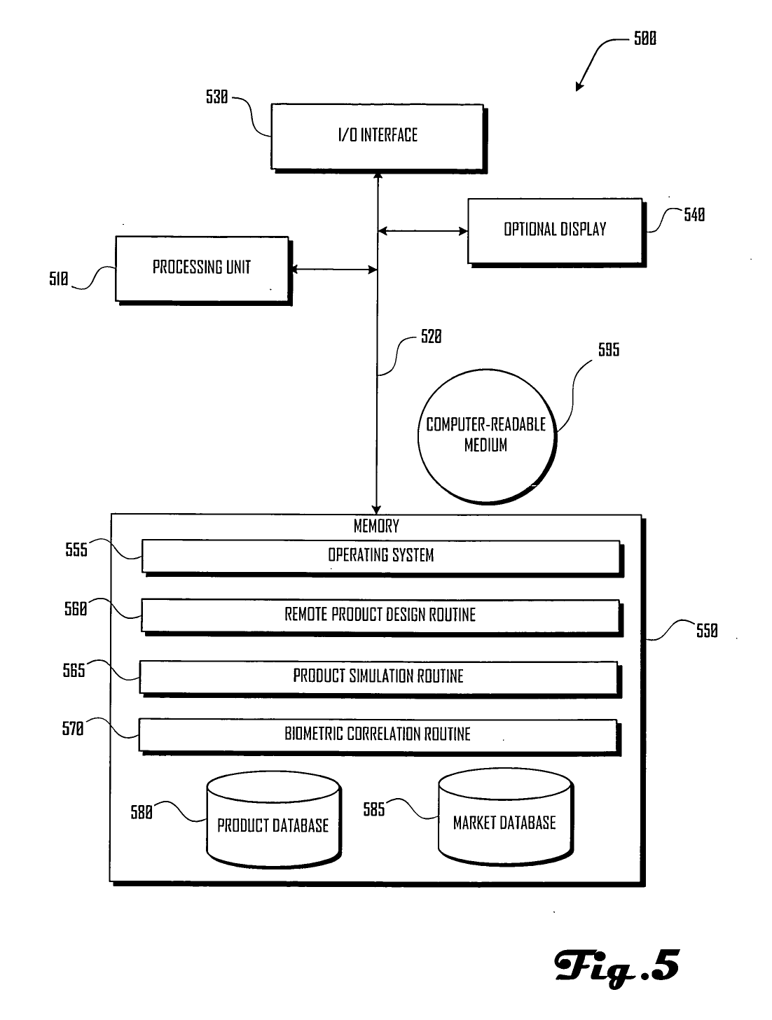

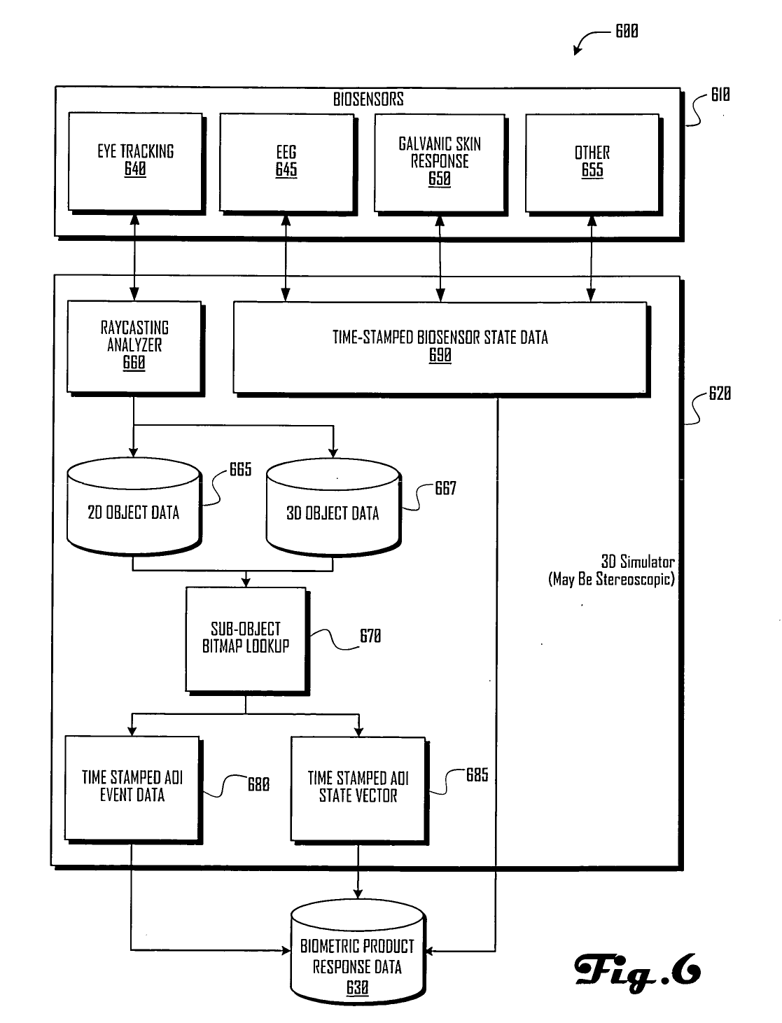

Referring now to FIG. 5, several components of a product package research and design server 500 are shown in accordance with various embodiments. In some embodiments, the design server 500 may include many more components than those shown in FIG. 5. However, it is not necessary that all of these generally conventional components be shown in order to disclose an illustrative embodiment. As shown in FIG. 5, the design server 500 includes an I/O communication interface 530 for connecting to the communication network 110, 210. The design server 500 also includes a processing unit 510, a memory 550, and an optional display interface 540, all interconnected along with the I/O interface 530 via a communication bus 520. The memory 550 generally comprises a random access memory (“RAM”), a read only memory (“ROM”), and a permanent mass storage device, such as a disk drive, flash device, or the like. The memory 550 stores program code for a number of applications, which includes executable instructions for remote product design routine 560, product simulation routine 565, and biometric correlation routine 570. One embodiment of the product simulation routine 565 is shown in greater detail below in FIG. 6.

In addition, the memory 550 also stores an operating system 555, a product database 580, and a market database 585. These software components may be loaded from a computer readable storage medium 595 into memory 550 of the design server 500 using a read mechanism (not shown) associated with a non-transient computer readable storage medium 395, such as a floppy disc, tape, DVD/CD-ROM drive, memory card, USB drive, or the like. In some embodiments, software components may also be loaded via the I/O communication interface 530, rather than via a computer readable storage medium 595. The product database 580 and market database 585 may include biometric product information and planogram information associated with different product package designs.

Referring now to FIG. 6, several components of a biosensitive response evaluation system having at least eye tracking device and at least one biosensor are shown in accordance with various embodiments. In one embodiment, the biosensitive response evaluation system is a market research server 600 that includes at least one detection module 610, a 3D simulator 620, and biometric product response data 630. In one embodiment, the biosensitive response evaluation device may also include at least one tablet, mobile device, or workstation computer. The 3D simulator 620 may generate a virtual reality simulation to improve the overall nature of marketing stimulus presented to consumers. In one embodiment, these simulations expand the shopping environment, giving the consumer experience a 3D effect. Instead of simply moving right and left along rows of packages in a flat 2D setting, consumers are able to experience the feeling of moving around in the aisle with a shopping cart, backing up, turning, approaching and withdrawing from the shelves, and so forth. This improves the fidelity of the experience to the point where manufacturers may have confidence that consumers provide unbiased reactions to the new packages and that may measure optical, neural, or other biometric effects. Accordingly, since response data 630 represents reactions to new packages based on immediate behavioral and involuntary biological responses rather than unreliable post-hoc consumer self-reporting, it is believed the 3D models and virtual reality simulations dramatically improve understanding of the specific impact that new packages, and demarcated AOI thereon, are having on consumers. 3D simulations have significantly changed the potential response data available to market researchers by allowing consumers to interact with more than just the front face of the new package, such as top, bottom, sides, and back face. Thus, response data 630 can be accurately correlated with a variety of outcome variables meaningful to the manufacturer, such as sales.

The biosensors 610, in one embodiment, can be any of a variety of input devices connected with wires or wirelessly to the biosensitive response evaluation device. In various configurations, the biosensors 610 may either provide raw data that still needs to be processed or the processing of at least a portion of the raw data may already occur on the sensor devices. The detection module 610 may include eye tracking systems 640, electro encephalography systems (EEG) 645, galvanic skin response (GSR) sensors 650, and other biodetection devices 655. In one embodiment, the eye tracking systems 640 is an optical biosensor. In one embodiment, the eye tracking systems 640 include one or more infrared cameras and infrared illuminators to provide eye tracking and gaze tracking information. In addition, the eye tracking system, in one embodiment, may also supply pupil dilation, head tracking, and even facial expression recognition information. Suitable eye tracking systems may be obtained from 3^{rd} party companies, such as EyeTech Digital Systems or Tobii. In one embodiment, EEG systems 645 include an array of moistened electrodes worn on the consumer's head to identify various responses including excitement, frustration, relaxation, or other mental states. Suitable EEG systems may be obtained from 3^{rd} party vendors, such as Emotiv, NeuroSky, and Thought Technologies. In one embodiment, the GSR sensors 650 include a wrist band, finger cap, or other skin conductance sensor to measure the relative electrical conductance of the skin, which varies with moisture level and can be an indication of psychological or physiological response to stimuli. Suitable GSR sensors may be obtained from 3^{rd} party vendors, such as Affectiva and Thought Technologies. Examples of other biodetection devices 655 may include heart rate monitors, heart rate variability sensors, blood volume pulsimetry sensors, Electrocardiography (EKG) systems, Electromyography (EMG) systems, respiration sensors, facial expression recognition systems, spatial tracking systems for gestural or physical manipulation analysis, and/or similar sensors or systems that are configured to collect biometric data from consumers exposed to a marketing stimuli.

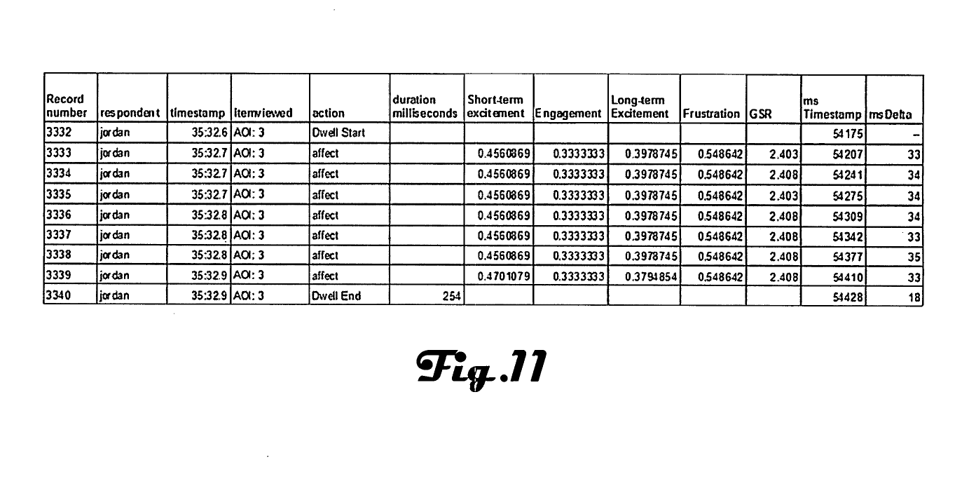

In one embodiment, inputs from all these sources are time-stamped and fed into a 3D simulator 620. In various embodiments, the 3D simulator 620 may run on the server, tablet, mobile device, or remote workstation computer. Input data from at least one eye tracking device, such as an optical biosensor, is communicated to a raycasting analyzer 660 that identifies simulation objects currently underneath the gaze position and provides the intersected surface coordinates on the digital representations of at least one package design as well as angles of incidence. The identified simulation objects are separated into 2D object data 665 and 3D object data 667. Each object has one or more bitmaps associated with it that may be hidden or visible. In one embodiment, bitmaps are typically 24-bits deep and the bitmap value at the point of intersection may encode an area of interest (AOI) identifier and/or vector that identifies which AOI is being observed. Moreover, using a sub-object bitmap lookup 670, the simulator 620 identifies exactly how far and/or in what direction from the center or edge of the AOI the point being observed resides. By maintaining time stamped AOI state vector 685 and distance information, noisy gaze tracking data may be disambiguated. From ray-casting and AOI analysis, time-stamped AOI event data 680 may identify events, such as when a particular AOI is entered or exited by a consumer viewing the market stimulus. In one embodiment, states are derived and recorded by the simulator 620, such as which AOI is currently being dwelled upon by the monitored consumer. This information, together with time-stamped sensor state data streams 690 are sent to one or more data files of a biometric product response database 630, which may simultaneously reside on the server, tablet, mobile device, workstation, and/or in the cloud. The simulator 620 records and reports data from market research experiments on both states and events, making sure that all states and events are time-coded so the ultimate analysis can take full advantage of the AOI's and their corresponding effects on consumers, thereby allowing coordination of data derived from eye tracking devices with data from biosensors. In one embodiment, “state” means the physiological state of the consumer at the moment he/she is being stimulated by an AOI, including a consumers brainwave patterns, heart rate, perspiration, microelectric skin changes, and so forth. FIG. 11 provides an example event in which research subject, Jordan, has certain measurable physiological states at precisely the moments (measured in milliseconds) the respondent is being stimulated by an AOI. In one embodiment, each event mean the stimulation and its duration, which is also called a dwell. In the example illustrated in FIG. 11 above, the dwell begins on record number 3332 and ends on record number 3340. It has a duration of 254 milliseconds, which is subdivided into roughly equal intervals of about 33-34 milliseconds each. This is so the biosensitive design and research system can check and report the state of the subject (Jordan) at each interval. The fact that each observation is time-stamped allows the system to know with certainty that the subject's physiological state is at a certain level at the very moment he/she is being stimulated by a particular AOI. Ultimately the system may correlate data events and marketing outcomes like a purchase decision. Once this data is collected for all of the identified AOI from the participating respondents, the results may be aggregated and correlated. The attached Table 1 shows an exemplary aggregation of detected stimulations and consumer purchase decisions for the marketing stimulus shown in FIG. 8, each correlation being separated by individual AOI shown in FIG. 9.

TABLE 1

| | | Correlation with |
|---|---|---|
| AOI | Description | Purchase |
| 901 | Character1 on front | 0.337 |
| 902 | Logo1 on front | 0.354 |
| 903 | Athlete1 | 0.732 |
| 904 | Athlete2 | 0.710 |
| 905 | Athlete3 | 0.662 |
| 906 | Athlete4 | 0.669 |
| 907 | Athlete5 | 0.708 |
| 908 | Athlete6 | 0.624 |
| 909 | Athlete7 | 0.683 |
| 910 | Athlete8 | 0.774 |
| 911 | Character2 on front | 0.339 |
| 912 | Logo2 on front | 0.411 |
| 913 | Olympics text on back | 0.423 |
| 914 | Official Team Athlete Cards | 0.474 |
| 915 | Cut' em out and keep 'em text on back | 0.464 |
| 916 | Logo3 on right side | 0.447 |
| 917 | USA Olympics logo on top | 0.495 |
| 918 | Whole Grain seal on top | 0.366 |
| 919 | Nutritional information on right side | 0.362 |
| 920 | Questions or comments on right side | 0.428 |
| 921 | Character3 on left side | 0.337 |
| 922 | Easy Open bag text on top | 0.254 |

Setting up the market research output data structures this way means the biosensitive design and research system can ultimately correlate data events and marketing outcomes like purchase decisions. In other words, it allows output data in the analysis phase of market research to be aggregated in a way that leads to these correlations. For example, the row associated with AOI 910 of the table indicates that the lifts consumers received when they viewed AOI 910 described as Athlete8 were more strongly correlated with a purchase decision than any other part, as the correlation coefficient is 0.774. In the example, the manufacturer or product marketer now knows that featuring Athlete8 on the package results in sales-producing lifts in positive feeling from consumers. This is important because now the manufacturer or product marketer can re-emphasize sales-producing elements like AOI 910 in future designs or re-designs of the package or any other consumer marketing materials designed for similar retail environments.

Although a product package design server 500 and a market research server 600 have been described that generally conform to conventional general purpose computing devices, the product package design server 500 and the market research server 600 may be any of a great number of different network devices capable of communicating with the communication network 110, 210 and obtaining applications, for example, mainframes, minicomputers, workstations, personal computers, or any other suitable computing device. In some embodiments, some or all of the systems and methods disclosed herein may also be applicable to distributed network devices, such as cloud computing, and the like. Available cloud resources may include applications, processing units, databases, and file services. In this manner, the product package design server 500 and the market research server 600 enable convenient, on-demand network access to a shared pool of configurable design and research resources, including product package design databases, market research results, targeted product solicitation and advertisement tools, consumer identification, and market research management related computing services and resources (e.g., networks, servers, storage, applications, and services) that can be rapidly provisioned and released with minimal management effort or service provider interaction. These services may be configured so that any computer connected to the communication network 110, 210 is potentially connected to the group of design and research applications offered by the product package design and the market research servers, processing units, and databases. In this manner, the product data maintained by the design server 500 and biometric product response data maintained by the market research server 600 may be accessible in a variety of ways by a variety of client devices, such as user access points and guest devices, for example, a personal computer, a handheld computer, a cell phone, a personal media console, a personal game console, or any other device that is capable of accessing the communication network 110, 210.

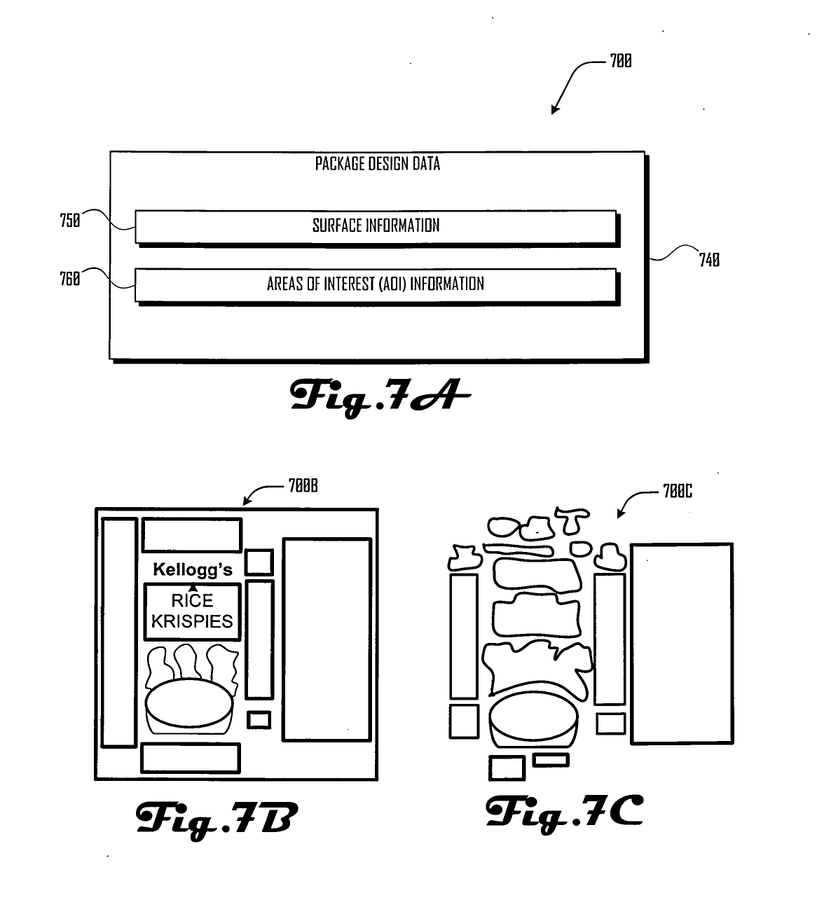

Referring now to FIGS. 7A-7C, several representations of product package design data 700 are shown in accordance with various embodiments. FIG. 7A illustrates a block diagram of several components of product package design data 700 in accordance with various embodiments. Package design data 740 includes surface information 750 and areas of interest (AOI) information 760. In one embodiment, the surface information 750 includes a plurality of package parts collectively forming a surface of a digital representation of a package design for a product. In one embodiment, AOI information 760 includes demarcation of the surface of the package design, each AOI surrounding at least one package part. FIG. 7B illustrates a graphical view of surface information 700B associated with the product package design data previously shown in FIG. 7A. FIG. 7C illustrates a graphical view of areas of interest (AOI) 700C associated with the product package design data previously shown in FIGS. 7A & 7B in accordance with various embodiments.

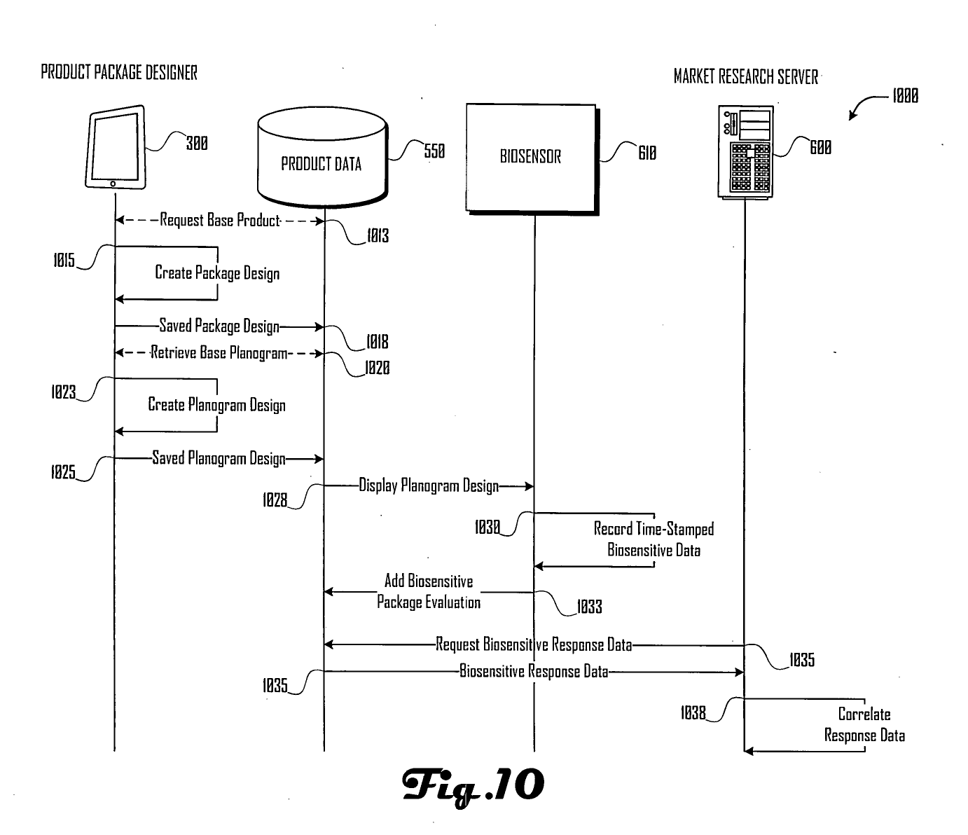

Referring now to FIG. 10, a communication diagram of a product package design system is shown in accordance with various embodiments. In particular, FIG. 10 shows communication between a mobile design device 300, product data 550, biosensors 610, and market research server 600. Initially, a designer may optionally request a base product 1013 from the available product data 550. The product package design device 300 creates a digital representation of a package design 1015 for a product, each package design including a plurality of package parts collectively forming a surface. The new product design is saved 1018 back to the product data 550. Base Planograms may optionally be retrieved 1020 from product data 550. The base planogram may be modified to present replications of typical supermarket (or other retail) shelves with the new package design included amid clutter products (i.e., competitive products). The created planogram design 1023 allows consumers to choose items from the shelves using their mouse (or finger, if on a tablet or smartphone), review them, and decide what to buy. The saved planogram design 1025 is saved with the associated product data 550.

In the research phase, the saved planogram designs are displayed 1028 to a consumer respondent being monitored by biosensor 610. In addition to recording time-stamped biosensitive data 1030, the actions of viewing and buying are recorded and incorporated into a market research report. The biosensitive package evaluation data may be added 1033 to the product data 550. In various embodiments, the biosensitive package evaluation data may also be kept with response data.

In the correlation phase, the market research server 600 requests and receives biosensitive response data 1035 associated with the desired product data 550. The market research server 600 correlates response data 1038 similar to that previously shown in FIG. 11 for each consumer to identify correlations as previously shown in Table 1.

Although specific embodiments have been illustrated and described herein, it will be appreciated by those of ordinary skill in the art that alternate and/or equivalent implementations may be substituted for the specific embodiments shown and described without departing from the scope of the present disclosure. For example, other embodiments may employ biosensitive visual merchandising, and the like. Similarly, although exemplary embodiments are described above in reference to package design and related market research, similar methods may be employed in connection with other marketing research and advertising and the like. The scope of this disclosure is intended to cover any adaptations or variations of the embodiments discussed herein.

In particular, embodiments demonstrate that a practical analytical problem may be solved, in a way that existing competing systems do not solve, by embodiments of described biosensitive response evaluation systems including the BioNimbus™ system currently offered by Cascade Strategies Inc., which provides statistically valid correlations between the time-coded aggregate biometric stimuli provided to a consumer by Areas of Interest (AOI's) on an object (e.g., a retail package) and a practical outcome, such as sales. One practical problem solved by various embodiments of the described systems includes learning how strongly each AOI contributed to a particular outcome on a scalar hierarchical basis.

Finding empirical, numeric answers to the question of relative AOI contribution, have eluded both the scientific and marketing communities for some time. Expressed simply, both these communities wished to understand what individual package elements (e.g., a game, a promotion, cartoon characters, pictures of the product, ingredients, and so forth) worked hardest to produce a designated result, like sales, so that future iterations can re-emphasize those sales-producing elements. This gives the teams engaged in package design and re-design or supportive marketing useful information regarding packages. Preexisting systems could evaluate an isolated package in toto by providing continuous biometric data as the respondent was stimulated overall; but the systems were incapable of providing the proper degree of time-coding, synchronization of multiple input signals, discrete demarcation of AOI's that worked properly in conjunction with sub-object or bitmap-region detection and data recording based on consistent sampling epochs defined in milliseconds, mapping of the discrete biometric stimulus to the correct AOI, and aggregation of the synchronized signals so they could be accurately correlated with outcome variables (e.g., sales) to enable them to answer the question as it was honestly asked or in a context where multiple objects and or AOIs were also present. For these reasons, the preexisting systems could only go so far as to say “the package as a whole seems to stimulate the consumer (or not).” They had no mechanism to determine how hard an element of the package worked to produce a behavioral outcome like sales or how it performed in one or more contexts.

Embodiments of the biosensitive response evaluation system are robust enough to answer this higher-level question independently of the mode of detection. While some of the embodiments described above deal primarily with object, sub-object, or surface bitmap-region detection on virtualized dynamic 3D objects in virtual-reality space, this specific mode of detection is not a requirement for the proper functioning of the biosensitive response evaluation system. In fact, the ability of the biosensitive response evaluation system to tell a system user how strongly the biometric stimulus afforded by an AOI is related to a desirable outcome is not dependent on the mode of detection.

This means that virtually any type of stimulus can be presented to a subject or respondent in the biosensitive response evaluation system, and the real-time biometric response to parts of that stimulus can be ascertained. This fact opens the biosensitive response evaluation system to a breathtaking range of scientific measurements and experimentation.

For example, embodiments of the biosensitive response evaluation system can consistently answer the user's question about the relative power of parts of a stimulus when that stimulus is an aroma, a sound, or even multiple cacophonous events or stimulations such as those occurring at a sporting event or nightclub. This remains true as long as the input signal can be time-coded and synchronized with other signals such as the subject's biometric response signals. The previously described embodiments have already demonstrated that it can.

In the visual realm, embodiments of the biosensitive response evaluation system can also consistently answer the user's question about the relative power of parts of a stimulus when that visual stimulus occurs in different forms: e.g., static physical images (such as a poster), screen images (such as a website), 2D video, 3D video, or physical objects (such as a phone held in the hand).

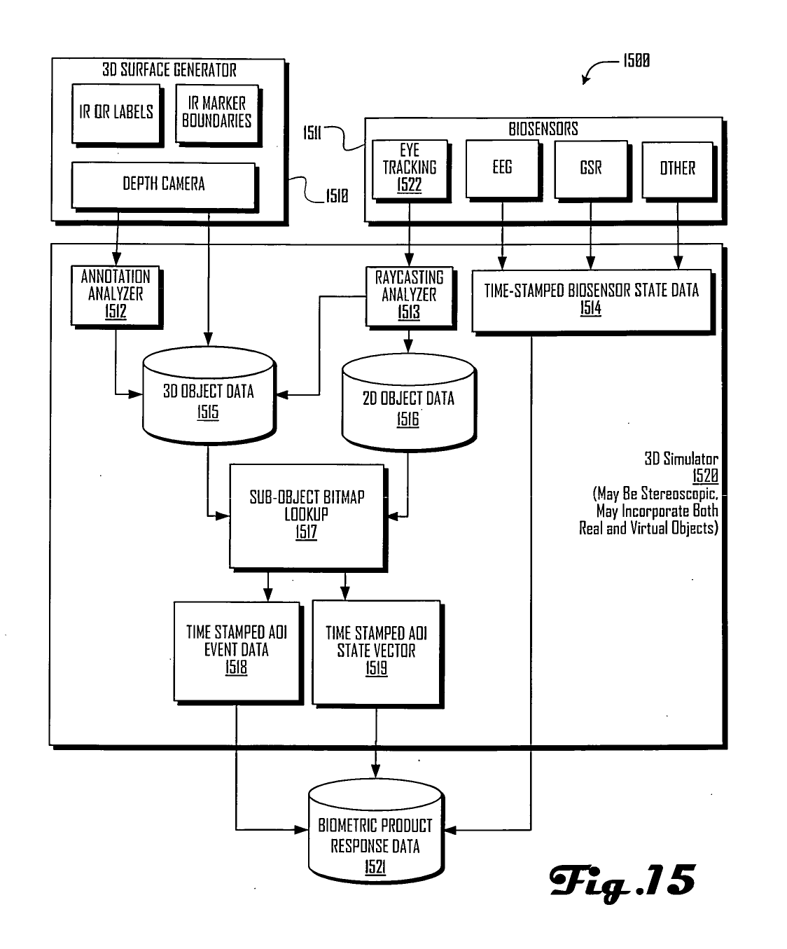

Referring now to FIG. 15, the function and output of a biosensitive response evaluation system, such as the BioNimbus™ system, when the mode of detection is a physical object occurring in space (i.e., “reality” as opposed to virtual reality) is shown. The array of biosensors 1511 may be used to determine the subject's biometric state at the moment of being stimulated by individual AOI's. The biosensor array 1511 is essentially the same as shown previously in FIG. 6. However, a 3D surface generator 1510 including a variety of devices and instruments are incorporated into the biosensitive response evaluation system 1500 in order facilitate accurate, time-coded, real-time detection that is synchronized with the subject's biometric signals. Among these are a depth camera, infrared QR labels, and infrared marker boundaries.

These are incorporated into the biosensitive response evaluation system 1500 to enable one to annotate space (i.e., space in reality, not virtual reality). One embodiment annotates space in the same way AOI's were demarcated (sub-objects or surface bitmap-regions) on virtualized 3D objects in virtual reality as described in the previously described embodiments: One embodiment confirms that a subject is focused on a particular AOI in space at the very same moment the system is also reading the subject's biometric response. In various embodiments, this coordination confirmation is used to validate the statistical correlations that the system will ultimately have to perform.

In the previously described embodiments, these confirmations were provided to the system by a series of steps which were clearly delineated, involving 3D object data, a sub-object bitmap lookup function, time-stamped AOI event data, and time-stamped AOI state vectors. In this current case in which reality is annotated, this same series of steps is used for confirmation; but the difference is that the depth camera dynamically generates the 3D scene and an annotation analyzer generates the AOI bitmap layer by computer vision analysis of regions demarked on physical surfaces in infrared ink and identified with infrared QR encoded labels. In the previous case the 3D scene and AOI bitmap layer are manually specified. This explains the use of a depth camera and the annotation analyzer.

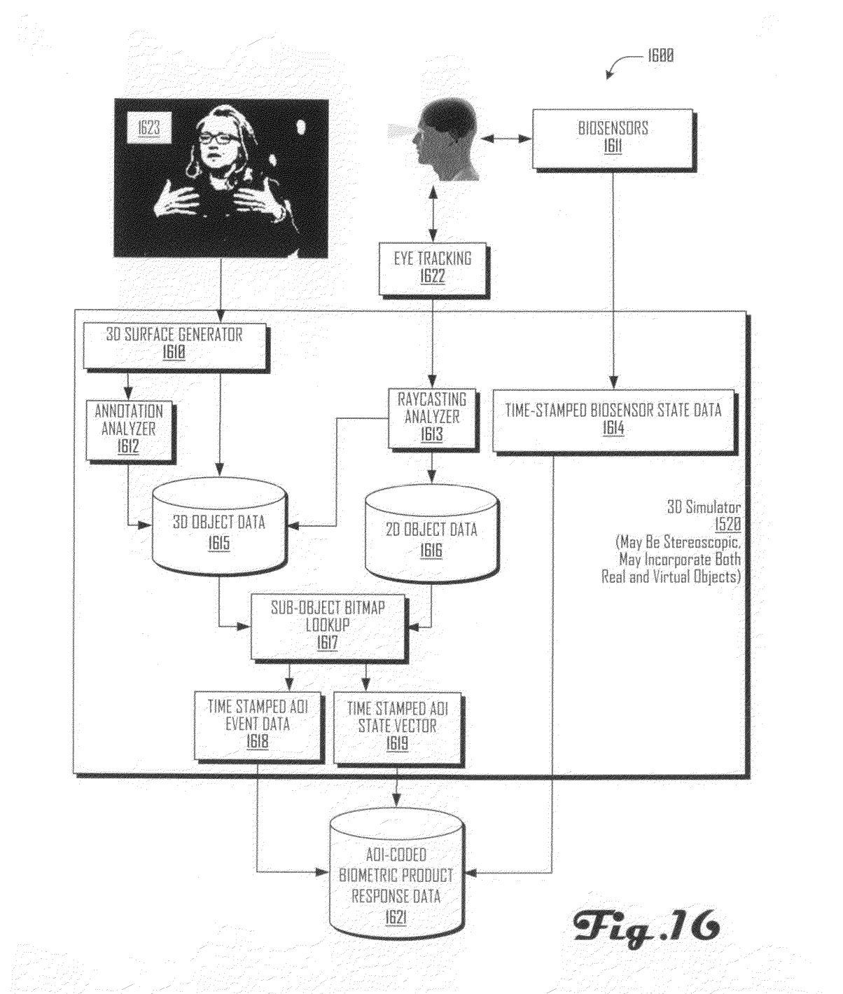

Turning now to FIG. 16, a biosensitive response evaluation system, such as the BioNimbus™ system, is illustrated that answers the practical questions asked by the scientific and research communities without requiring that the stimuli be sub-objects or bitmap regions on objects in virtual reality simulations. In this embodiment, the stimuli are regions of a 3D video of Hilary Clinton (1623), a well-recognized figure in the American political culture.

As subjects watch and listen to the 3D presentation, they send real-time time-coded biometric data 1614 to the Simulator 1620 via the Biosensors 1611. Simultaneously, subjects send synchronized real-time time-coded eye tracking data to the Raycasting Analyzer 1613 via Eye-tracking Equipment 1622.

As the video proceeds, the interaction of the 3D Surface Generator 1610, the Annotation Analyzer 1612, and the Raycasting Analyzer 1613 determine which AOI's the subject is focused on at precisely the moments the system reads the subject's real-time biometric signals. While the video is 3D, surfaces or regions are generated on which the subject can focus at particular moments in time—e.g., Clinton's left hand, Clinton's mouth, etc. The 3D Surface Generator 1610 uses its internal components (e.g., a depth camera, infrared QR labels, and infrared marker boundaries, as shown in FIG. 15) to do this. When the Raycasting Analyzer 1613 indicates that the subject is focused on a specific region, e.g., Clinton's left hand, the 3D Surface Generator resolves that focus to a QR Code which pertains to Clinton's left hand. The QR Code doesn't have any particular meaning for the analysis at that point (other than as a numeric placeholder) until it is resolved to a simpler form which can be read and understood in the analysis phase.

This “simpler form” is a series of numbered AOI's. In one embodiment, numbered AOI's are used for the correlations the system will ultimately have to calculate in the analysis phase. Table 2 below provides an example of a simple list of such AOI's.

TABLE 2

| AOI | Description |
|---|---|
| 31 | Left eye |
| 32 | Right eye |
| 33 | Left hand |
| 34 | Right hand |
| 35 | Neck |
| 36 | Left shoulder |
| 37 | Right shoulder |
| 38 | Forehead |
| 39 | Mouth |
| 40 | Nose |
| 41 | Left cheek |
| 42 | Right cheek |
| 43 | Breast |
| 44 | Torso |
| 45 | Hair-top |
| 46 | Hair-left |
| 47 | Hair-right |

Conversion to this “simpler form” occurs through the interaction of several components in the 3D Simulator 1620. The Annotation Analyzer 1612 converts the QR Code regional raw data on the surfaces on which the subject has focused to 3D Object data 1615, which are combined with 2D Object Data 1616 from the Raycasting Analyzer 1613. These data are linked (indexed) by the millisecond time codes by which the incoming data are tagged. The 3D Object Data 1615 and the 2D Object Data 1616 are fed to the Sub-object Bitmap Lookup routine 1617. The routine issues Time-stamped AOI Event Data 1618 and Time-stamped AOI State Data 1619, which are combined with the synchronized Time-stamped Biometric Sensor State Data 1614 and sent as a manageable dataset to the analysis phase. In at least one embodiment, the term “manageable dataset” means the AOI-coded Biometric Response Data 1621. This is the dataset that is used in the analysis phase.

Table 3 below, which is an extract from a full dataset, illustrates how the AOI-coded Biometric Response Data 1621 appear in the analysis phase.

TABLE 3

| Re- | Area of | | Biometric | | |
|---|---|---|---|---|---|
| spondent | Focus | Description | State | msTimestamp | msDelta |
| jeffrey | AOI 33 | Left hand | | 131115 | 19 |
| jeffrey | AOI 33 | Left hand | 0.7990714 | 131129 | 14 |
| jeffrey | AOI 33 | Left hand | 0.7990714 | 131163 | 34 |
| jeffrey | AOI 33 | Left hand | 0.7990714 | 131197 | 34 |
| jeffrey | AOI 33 | Left hand | 0.7990714 | 131230 | 33 |
| jeffrey | AOI 33 | Left hand | 0.7514963 | 131264 | 34 |
| jeffrey | AOI 33 | Left hand | 0.7514963 | 131298 | 34 |
| jeffrey | AOI 33 | Left hand | 0.7514963 | 131331 | 33 |
| jeffrey | AOI 33 | Left hand | 0.7514963 | 131365 | 34 |
| jeffrey | AOI 33 | Left hand | 0.7514963 | 131400 | 35 |
| jeffrey | AOI 33 | Left hand | 0.6163678 | 131432 | 32 |
| jeffrey | AOI 33 | Left hand | 0.6163678 | 131467 | 35 |
| jeffrey | AOI 33 | Left hand | 0.6163678 | 131500 | 33 |
| jeffrey | AOI 33 | Left hand | 0.6163678 | 131534 | 34 |
| jeffrey | AOI 33 | Left hand | 0.6096299 | 131567 | 33 |
| jeffrey | AOI 33 | Left hand | 0.6096299 | 131601 | 34 |
| jeffrey | AOI 33 | Left hand | 0.6096299 | 131635 | 34 |
| jeffrey | AOI 33 | Left hand | 0.6096299 | 131668 | 33 |
| jeffrey | AOI 33 | Left hand | 0.6096299 | 131702 | 34 |
| jeffrey | AOI 33 | Left hand | 0.5805582 | 131736 | 34 |
| jeffrey | AOI 33 | Left hand | 0.5805582 | 131771 | 35 |
| jeffrey | AOI 33 | Left hand | 0.5805582 | 131803 | 32 |
| jeffrey | AOI 33 | Left hand | 0.5805582 | 131837 | 34 |
| jeffrey | AOI 33 | Left hand | 0.5805582 | 131871 | 34 |
| jeffrey | AOI 33 | Left hand | 0.5291125 | 131904 | 33 |
| jeffrey | AOI 33 | Left hand | 0.5291125 | 131906 | 2 |

In this example, the subject Jeffrey has been focused on Clinton's left hand for approximately 800 milliseconds. During this interval of time, Jeffrey has recorded the biometric levels shown in the column “Biometric State.”

The biosensitive response evaluation system correlates the aggregate of all Jeffrey's biometric state data relating to focus on the left hand with Jeffrey's “yes” or “no” vote for Hilary Clinton, which is a practical example of an outcome variable (dependent or criterion variable). The system then correlates the aggregate of all Jeffrey's biometric state data relating to focus on the left shoulder with Jeffrey's “yes” or “no” vote for Hilary Clinton, then does the same with the mouth, and so forth, enabling us to express statistical relationships between each AOI and the outcome. Table 4 below expresses such an outcome as a “no” vote for Hilary Clinton.

TABLE 4

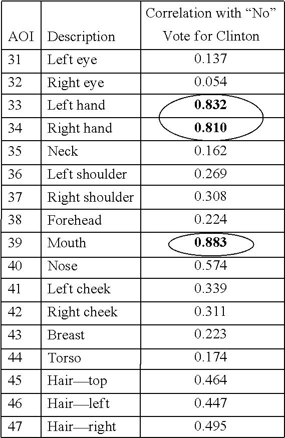

The biosensitive response evaluation system is thus able to answer a practical question political consultants may have, which is: what is it about Hilary Clinton's personal presentation that most strongly impedes a vote for her? In the example above, the political consultants would want to consider her hand gestures, or perhaps a unique way of pursing her lips, both of which are strongly correlated with a “no” vote for Hilary Clinton.

While the example given may be seen by some as trivializing a decision as grave as choosing a president, it nevertheless accurately describes how the biosensitive response evaluation system is not dependent on a single mode of detection to provide an answer to practical questions. In this case, a fairly elaborate mode of detection was used. A reasonable reader will be able to see that, given the biosensitive response evaluation system's adaptability to numerous modes of detection, the example may easily be expanded to Hilary Clinton's voice tone (an audio signal), her voice level (an audio signal), or certain mannerisms (e.g., a flourish of the hand, which in in the biosensitive response evaluation system would be a series of surface detections from millisecond time X₁ to millisecond time X₂, or a way of laughing, which in the biosensitive response evaluation system would be decoded as both an audio and a surface-detection signal occurring simultaneously from Time X₁ to Time X₂). All sources of input can be submitted by the biosensitive response evaluation system to procedures whereby they answer practical questions people have, as long as the input signals can be time-coded and synchronized with other signals such as the subject's biometric response data. The previously described embodiments, as well as this embodiment, have demonstrated that they can.

While the above embodiment provides an illustration of the working of the biosensitive response evaluation system when the stimuli are a series of AOI's in a 3D video, as noted before the biosensitive response evaluation system is independent of the mode of detection; it answers the same practical questions for researchers and scientists regardless of the stimulus. More explicitly, the biosensitive response evaluation system functions in essentially the same way if any of the following stimuli are used: a physical object in space (e.g., a phone held in the hand), 2D Video (e.g., ads or trailers), Static images (e.g., print ad or POS material), Websites, Sounds/human voice (e.g., public safety announcement), Aromas, Multiple ambient stimuli (e.g., casino experience, cacophony), and 2D VR objects (e.g., flat images).

When any of these stimuli are used, the biosensitive response evaluation system's mode of analysis is the same as described in [Para 57] to [Para 64] and illustrated in FIG. 16 above. More specifically, in various embodiments, the components of the biosensitive response evaluation are used as described in [Para 57] to [Para 64] above and illustrated in FIG. 16 to resolve the research subject's areas of focus to numbered AOI's which are properly time coded and synchronized with other data, so they can be easily understood and submitted to the kind of statistical correlation analysis described above. What would change would be the specific components of the biosensitive response evaluation system that are used to detect and annotate the research subject's areas of focus prior to their being rendered as time-stamped AOI event or state data in order to submit them to this analysis. In fact, the components used for this purpose would simply fit the nature of the stimulus (e.g., if a depth camera is needed, it is used).

The biosensitive response evaluation system has a great degree of flexibility because its essential functions remain effective regardless of whether the AOI's are manually specified beforehand and are thus embedded in the stimulus material itself or they are determined post hoc. In the latter case, new AOI layers can be inserted and used with previously gathered eye-tracking data. This process can be used iteratively to refine analysis. Whether the AOIs are pre-specified or defined afterward, the mode of analysis and the fundamental method of resolving areas of focus to understandable forms that can be submitted to statistical analysis remain the same.

In one embodiment, the biosensitive response evaluation system operates when the stimulus is a physical object in space. In this case, the mode of analysis is still as described in [Para 57] to [Para 64] above and illustrated in FIG. 16. The mode of detection is adjusted to fit the physical nature of the stimulus material. This is as described in [Para 57] to [Para 64] above and illustrated in FIG. 16.

In another embodiment, the biosensitive response evaluation system operates when the stimulus is a static image (e.g., a print ad or a poster). In this case, the mode of analysis is as described in [Para 57] to [Para 64] above and illustrated in FIG. 16. The mode of detection is adjusted to fit the 2D nature of the stimulus material. This is as described in the previously described embodiments—i.e., the AOI's are manually specified beforehand and are embedded in the stimulus material itself.

In another embodiment, the biosensitive response evaluation system operates when the stimulus is a website. In this case, the mode of analysis is as described in [Para 57] to [Para 64 ] above and illustrated in FIG. 16. The mode of detection is adjusted to fit the 2D on-screen nature of the stimulus material. This is as described in the previously described embodiments—i.e., the AOI's are manually specified beforehand and are embedded in the stimulus material itself.

In another embodiment, the biosensitive response evaluation system operates when the stimulus is a 2D video. In this case, the mode of analysis is as described in [Para 57] to [Para 64 ] above and illustrated in FIG. 16. The mode of detection is adjusted to fit the 2D on-screen nature of the stimulus material. This is as described in the previously described embodiments—i.e., the AOI's are manually specified beforehand and are embedded in the stimulus material itself.

In another embodiment, the biosensitive response evaluation system operates when the stimuli are 2D objects in a virtual reality environment (e.g., the front face of a cereal box). In this case, the mode of analysis is as described in [Para 57] to [Para 64] above and illustrated in FIG. 16. The mode of detection is adjusted to fit the 2D on-screen nature of the stimulus material. This is as described in the previously described embodiments—i.e., the AOI's are manually specified beforehand and are embedded in the stimulus material itself.

In another embodiment, the biosensitive response evaluation system operates when the stimuli are sounds (e.g., a public safety announcement on a train). In this case, the mode of analysis is as described in [Para 57] to [Para 64] above and illustrated in FIG. 16. The mode of detection is adjusted to fit the audio nature of the stimulus material. The detection data are time-coded and synchronized in such a way that the system 1600 can read the respondent's biometric state at the same time certain audio events are occurring. An “audio event” in this context refers to sounds that occur from Time X₁ to Time X₂ in a time-coded dataset.

In another embodiment, the biosensitive response evaluation system operates when the stimuli are aromas (e.g., the smell of brewing coffee). In this case, the mode of analysis is as described in [Para 57] to [Para 64] above and illustrated in FIG. 16. The mode of detection is adjusted to fit the olfactory nature of the stimulus material. The detection data are time-coded and synchronized in such a way that the system 1600 can read the respondent's biometric state at the same time certain aroma events are occurring. An “aroma event” in this context refers to sounds that occur from Time X₁ to Time X₂ in a time-coded dataset.

In another embodiment, the biosensitive response evaluation system operates when multiple ambient stimuli are used to evoke a biometric response from the subject (e.g., the cacophony and the commotion of a casino or a night club). In this case, the mode of analysis is as described in [Para 57] to [Para 64] above and illustrated in FIG. 16. The mode of detection is adjusted to fit the chaotic nature of the stimulus material. The detection data are time-coded and synchronized in such a way that the system 1600 can read the respondent's biometric state at the same time certain ambient events are occurring. An “ambient event” in this context refers to disturbance in the environment that occurs from Time X₁ to Time X₂ in a time-coded dataset (e.g., a “big win” siren going off in a casino).

As noted previously, despite specific embodiments being illustrated and described herein, it will be appreciated by those of ordinary skill in the art that alternate and/or equivalent implementations may be substituted for the specific embodiments shown and described without departing from the scope of the present disclosure. Similarly, although exemplary embodiments are described above in reference to package design and related market research, similar methods may be employed in connection with other marketing research and advertising and the like. Accordingly, the scope of this disclosure is intended to cover any adaptations or variations of the embodiments discussed herein.

1. A biosensitive response evaluation method comprising:
resolving areas of focus of a monitored subject to at least one time-coded biometric stimulus applied to the monitored subject relative to demarcated Areas of Interest (AOI); and
correlating a detected physiological effect directly associated with a particular demarcated AOI to a decision made by the monitored subject, the correlation being independent of detection modes employed to identify corresponding physiological effects.

2. The method as recited in claim 1, wherein the at least one stimulus is selected from the group consisting of a physical object in space, a 2D video, a static image, a human voice, an aroma, and a 2D VR object.

3. The method as recited in claim 2, wherein the at least one stimulus includes multiple ambient stimuli.

4. The method as recited in claim 1, wherein the demarcated AOI are determined post hoc.

5. The method as recited in claim 1, wherein the demarcated AOI are embedded in the at least one stimulus.

6. The method as recited in claim 1, wherein the resolving includes determining a biometric state of the monitored subject at the moment of stimulation and simultaneously applying a 3D generator to any objects detected in real space to generate time-stamped AOI event data.

7. The method as recited in claim 1, wherein the demarcated AOI annotate space using a 3D generator having a depth camera, an infrared QR label generator, and an infrared marker boundary generator.

8. The method as recited in claim 1, further comprising mapping discrete biometric stimulus to the corresponding demarcated AOI, upon detecting at least one physiological effect directly associated to the discrete biometric stimulus.

9. The method as recited in claim 1, further comprising sampling a plurality of biometric data to determine how strongly the biometric stimulus afforded by a particular AOI is related to a desirable outcome.

10. A computer program product residing on a non-transient computer readable storage medium having a plurality of instructions stored thereon which, when executed by a processor, cause the processor to perform operations comprising:
demarcating a plurality of areas of interest (AOI) on objects detected upon application of discrete biometric stimulus, each AOI surrounding a different part of the detected object;
registering a physiological effect of each demarcated AOI relative to other physiological effects of other demarcated AOI; and
correlating the registered relative physiological effect of each demarcated AOI with a designated behavior.

11. The method as recited in claim 10, wherein the correlating is independent of the detection mode used to register the corresponding physiological effects.

12. The method as recited in claim 10, wherein the object is selected from the group consisting of a physical object in space, a 2D video, a static image, an audible noise, and an aroma.

13. A biosensitive response evaluation system comprising:
a biosentive monitoring array having eye tracking capability, the array configured to detect physiological effects at the moment of stimulation;
a surface generator to demarcate Areas of Interest (AOI) on objects detected at the moment of stimulation; and
a simulator to aggregate detected physiological effects with demarcated AOI and generate AOI-coded biometric response data.

14. The system recited in claim 13, wherein the surface generator includes a depth camera.

15. The system recited in claim 14, wherein the surface generator additionally includes a boundary generator and label generator to annotate detected objects and demarcate AOI.

16. The system recited in claim 15, further comprising an annotation analyzer configured to identify and demarcate objects in space and a raycasting analyzer configured to identify any objects currently under gaze and to provide intersected surface coordinates as well as angles of incidence.

17. The system recited in claim 14, wherein the biosentive monitoring array includes at least one facial expression recognition system, electro encephalography system (EEG), galvanic skin response sensor, heart rate monitor, heart rate variability sensor, blood volume pulsimetry sensor, Electrocardiography (EKG) system, Electromyography (EMG) system, and/or respiration sensor.

18. The system recited in claim 14, wherein the AOI-coded biometric response data includes time-stamped biosensitive sensor streams with AOI event data and AOI state vector data.
